(19) United States
(12) Patent Application Publication
(10) Pub. No.: US 2021/0203778 A1
(43) Pub. Date: Jul. 1, 2021

(54) PREVENT OR DETER UNWANTED CALLS USING PSEUDO RINGBACK SOUNDS

(71) Applicant: Robert Earl Banks, Davenport, FL (US)

(72) Inventor: Robert Earl Banks, Davenport, FL (US)

(21) Appl. No.: 16/728,755

(22) Filed: Dec. 27, 2019

(51) Int. Cl. H04M 3/436; H04M 3/42

(52) U.S. Cl. CPC H04M 3/436; H04M 2201/14; H04M 3/42017

(57) ABSTRACT

Deterring or defeating Robocallers and telemarketers by preventing incoming calls from ringing a called phone while deceptive pseudo ringback sounds are returned to the caller while the called phone is not ringing. Ringback sounds are incorrectly associated with a called phone ringing; ringback sounds only indicate a call is connected. This methodology does not require any identification of nor information about a call.

### CROSS REFERENCE TO RELATED APPLICATIONS

Not Applicable

### BACKGROUND OF THE DISCLOSED TECHNOLOGY

People's immediate needs for gratification is being exploited by the unanticipated creation of annoying computer-generated telemarketing techniques like Robo calls.

Robo calls and other annoying telemarketing calls are a lucrative and a national problem. These calls are increasingly sophisticated in their ability to call from any country and to imitate any caller name or number.

Prior attempts to screen, identify' and block unsolicited calls seems to be highly unproductive.

Telemarketers strive for instantaneous connection to a called phone. Being annoyed by their sales pitches is bad enough; but now call recipients are repeatedly receiving one, two, or three ring hang-ups from telemarketers.

The herein disclosed technology does not require information about or identification of a caller to deter or defeat the unwanted call.

### BRIEF SUMMARY OF THE DISCLOSED TECHNOLOGY

Current methods try to defeat or deter Robocalls, telemarketers, and other annoying callers by relying on call screening, matching calling number to a database of undesirable phone numbers, or other identification techniques.

In this disclosed technology, preventing these unwanted calls, while wasting the caller's time, is accomplished by deceiving a caller into thinking a called phone is ringing; when it is not.

The basis if this technology is simplicity and deception, a very different tactic to deter or defeat annoying callers.

When this ringer delay disclosed technology is employed on a phone, unwanted callers never know if the phone they are calling is actually ringing. Additionally, one, two, and three ring hang ups will not bother a user of a phone that uses ringer delay technology.

This disclosed technology is applied to all incoming calls. Incoming calls are not interrogated and no action is taken to identify the caller. Incoming calls are just temporarily delayed while the caller is deceived into waiting for a prompt answer.

The disclosed exemplary embodiments-take advantage of a telephone circuit's connection between an incoming call and a called phone. The embodiments use a called phone connection to temporarily silence the ringer of a called phone, a ringer delay.

A telephone circuit of a telecommunication system completes the connection of an incoming call from a caller phone to a called phone. When the connection is made between the caller and the called phone; the connection informs the caller phone that a connection is made by sending ringback tones to the caller phone.

Simultaneously with the telephone circuit connection the called phone ringer is silenced for a temporary, fixed, variable or random period of time.

When the caller hears ringback tones, the caller incorrectly associates the ringback tones with the ringing of the called phone. Ringback tones only signify to the caller that the two phones are connected; not that the called phone is ringing.

This ringer delay technology prevents the called phone from ringing for the duration of the ringer delay deceiving the impatient caller into thinking the caller phone is ringing.

The ringback tones generated during the called phones ringer delay are deemed to be pseudo ringback tones. These pseudo ringback tones are used to deceive callers that require a prompt answer to their call. The no immediate answer created by a ringer delay called phone encourages an impatient telemarketing caller to hang up.

In one embodiment, of this technology, a telecommunication system routes and connects an incoming call to a called phone over a telephone circuit and delays ringing the called phone for a temporary period of time, a ringer delay. During the ringer delay, deceptive, pseudo ringback tones are sent to the caller.

When the above ringer delay is implemented by the telecommunication system telephone circuit using random ringer delays an unusual amount of uncertainty will be imposed on impatient, annoying callers that use automated systems to simultaneously contact multiple phones.

In another embodiment the disclosed technology incoming calls are handled by a smart phone. A telecommunication system routes and connects a call to a smart phone over a telephone circuit. The ringer delay of the smart phone is activated and controlled by a ringer delay operating system program or an installed app, application, within the smart phone which initiates and controls the ringer delay while allowing pseudo ringback tones to be sent to the caller.

This embodiment also contemplates the smart phone user may be able to select the type of ringer delay; fixed, variable, or random in addition to selecting the duration of the ringer delay.

An embodiment allows the forwarding of any land line or other incoming call to a smart phone using ringer delay technology. A ringer delay technology smart phone will receive the forwarded call and prevent the call from ringing the smart phone. The forwarded call is treated by the smart phone as if the call was made directly to the smart phone.

In another embodiment, an incoming phone call is connected to a ringer delay ringtone smart phone that does not contain a ringer delay operating system program or app. In this embodiment the ringer delay is created by a ringer delay ringtone in use on a ringer delay ringtone smart phone. When the telephone circuit makes the connection between the caller and the ringer delay ringtone smart phone; the ringer delay ringtone begins playing silence on the ringer delay ringtone smart phone, initiating a temporary ringer delay that prevents the smart phone from ringing while allowing deceptive pseudo ringback tones to be sent to the caller.

The temporary ringer delay prevents the ringer delay ringtone smart phone from ringing for a temporary fixed number of seconds after the call is connected.

At the end of the temporary ringer delay, ringback tones continue back to the caller and ringer delay ringtone plays audible tones or music on the called phone.

The smart phone user is not audibly aware the ringer delay occurred.

During the audible part of the ringer delay ringtone, all regular features on the smart phone are active.

### BRIEF DESCRIPTION OF THE DRAWINGS

FIG. 1 illustrates a method of creating a ringer delay on a called phone when receiving an incoming call over a telephone circuit of a telecommunications system.

FIG. 2 illustrates a method of creating a ringer delay on a smart phone when receiving an incoming call.

FIG. 3 illustrates a method of creating a ringer delay by a ringtone on a smart phone.

### DETAILED DESCRIPTION OF THE DISCLOSED TECHNOLOGY

The ringer delay technology disclosed herein provides for systems and methods that deter or defeat Robocallers and other telemarketers by preventing all incoming calls from ringing a called phone for a predetermined period of time, a ringer delay, during which deceptive, pseudo ringback tones are sent to the caller.

When an automated dialing system contacts a called phone using this disclosed technology, the annoying caller will have to decide which one of the numerous phones they simultaneously called might be using a ringer delay period? If they contact a phone using this technology they will not know when or if the called phone will be answered. Also, all one, two, and three ring hang ups will not ring a called phone that is using this ringer delay technology.

In all embodiments of the disclosed technology described below, the telecommunication system telephone circuit connection of a caller phone to a called phone is used to initiate a ringer delay, silence, on a called phone while allowing deceptive pseudo ringback tones to be sent to the called phone.

In all embodiments where the term smart phone is used, smart phone is meant to encompass not only smart phones but also mobile phones and other devices like cell phones, watches, and tablets that receive incoming calls over a telephone circuit connection that connects a caller phone with a called phone and announces the call using a ringer.

These embodiments contemplate the term ringer delay encompasses all terms that may be used to silence the ringer, ringtone, or other audible sound indicating an incoming call to a called phone.

These embodiments contemplate that pseudo ringback tones may be sent to the caller before the call is connected to the called phone.

Unlike prior art, these incoming call handling methods do not require any information about the incoming call.

Embodiments of the ringer delay disclosed technology are described below with references to figures provided.

It is understood that one versed in the terms used in telecommunication systems and telephone circuits will understand all the terms used in this disclosed technology. It also anticipates that methods other than the current telephone circuit connection processes in wide use can be used to connect phones and allow ringback tones to a caller.

The following embodiments illustrations are only illustrative and not restrictive. This disclosure anticipates the using of these disclosures in combination with one another.

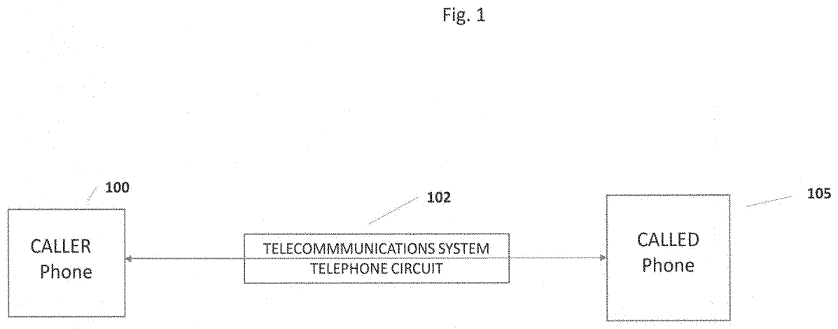

FIG. 1 illustrates a method of creating a ringer delay 150 on a called phone 105 when receiving an incoming call over a telephone circuit of a telecommunications system.

A caller phone 100 is connected to the called phone 105 and a telephone system connection initiates a ringer delay 150 that temporarily silences the ringer 110 of the called phone 105 for a period of time set by the ringer delay 150.

Simultaneously with the completion of the telephone circuit, ringback tones 130 are sent to the caller phone 100.

Ringback tones 130 only indicate the caller phone 100 is connected to the called phone 105. The caller hears ringback tones 130 during the ringer delay 150 and mistakenly associates the ringback tones 130 with the ringing of the called phone 105. These mistaken ringback tones 130 are deemed to be pseudo ringback tones 120.

The telephone system controls the duration of the ringer delay 150 for a temporary period of time set by the ringer delay 150

The ringer delay 150 prevents the called phone 105 from ringing, ringer 110 off, for the duration of the ringer delay 150.

Before the telephone circuit ringer delay 150 expires and while an annoying caller is hearing deceptive pseudo ringback tones 120; the annoying, impatient caller is persuaded to hang up and call another more promptly answered phone.

A called phone 105 ringer delay 150 is typically equal to about, but not limited to, four ringback tones 120 heard by the caller. Four ringback tones 120 are equal to, but is not limited to, fifteen seconds during which the caller is not audibly aware of the incoming call. Usually four ringback tones 120 are a sufficient amount of time to deter most annoying callers. The fifteen second ringer delay 150 prevents annoying one, two, or three ring hang ups from reaching a called phone 105.

After the telephone circuit ringer delay 150 time expires, the called phone 105 ringer delay 150 is turned off; the ringer 110 is turned on; the telephone circuit remains complete; ringback tones 130 replace pseudo ringback tones 120 and continue back to the caller phone 100, while the called phone 105 audibly rings.

When the telephone circuit system uses a randomly varied ringer delay 150 for each caller, numerous logistical connection problems are created for automated and high-volume annoying callers. The impatient caller has no way of knowing how many rings it will take before a called phone 105 actually rings. If annoying callers just increase the time they stay on the line, their onerous productivity thru put will be significantly decreased.

If the caller is patient and stays on the line until the called phone 105 temporary ringer delay 150 expires; the user of the called phone 105 can answer the call and converse with the patient caller 140, hang up 170; or let the call go to voice mail 160, if available.

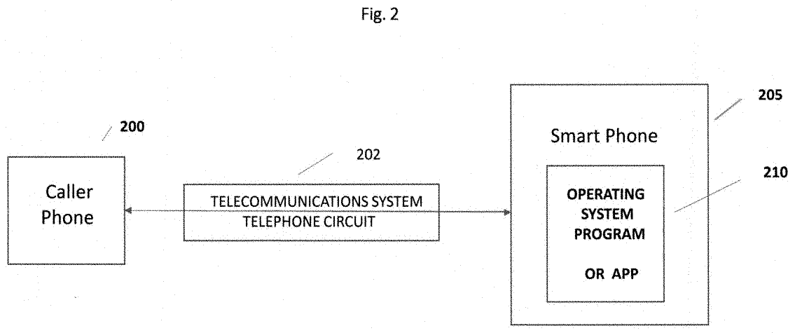

FIG. 2 illustrates a method of creating a ringer delay 215 on a ringer delay smart, RDS, phone 205 when receiving an incoming call on the RDS phone 205.

A telecommunication system telephone circuit connects an incoming call from a caller phone 200 to an RDS phone 205, completing a telephone circuit.

Simultaneously with the completion of the telephone circuit connection, ringback tones are sent to the caller phone 200 and the ringer delay operating system program or app 210 on the RDS phone 205 is activated turning the RDS phone 205 ringer delay 215 on and the RDS phone ringer 230 off. The RDS phone 205 is silenced for a temporary period of time set by the ringer delay 215.

The ringer delay 215 keeps the RDS phone 205 from ringing for the duration of time set by the ringer delay 215 and allows ringback tones to go to the called phone 200.

Ringback tones only indicate the caller phone 200 is connected to the RDS phone 205. The caller hears ringback tones during the ringer delay 215 and mistakenly associates the ringback tones with the ringing of the RDS phone 205. These mistaken ringback tones are deemed to be pseudo ringback tones 220.

The temporary ringer delay 215 time set by the ringer delay operating system program or app 210 can also be set by the RDS phone 205 user.

Before the called RDS phone 205 ringer delay 215 expires and while an annoying caller is still hearing deceptive pseudo ringback tones 220; the annoying, impatient caller is persuaded to hang up and call another more promptly answered phone.

An RDS phone 205 ringer delay 215 is typically equal to about, but not limited to, four ringback tones as heard by the caller. Four ringback tones are equal to, but not limited to, fifteen seconds during which time the caller is not audibly aware of the incoming call. Four ringback tones prevents annoying one, two, or three ring hang ups from ringing the RDS phone 205.

After the ringer delay 215 expires, the ringer delay operating system program or app turns the RDS phone 205 ringer delay 215 off; the RDS phone 205 ringer 230 on; the telephone circuit remains complete, ringback tones 235 replace pseudo ringback tones 220 going to the caller phone 200; and the RDS phone 205 begins to audibly ring.

If the caller has been patient and stays on the line until the temporary ring delay 215 expires; the RDS phone 205 user can answer the call and converse with the patient caller 240; hang up 250; or let the call go to voice mail 260, if available.

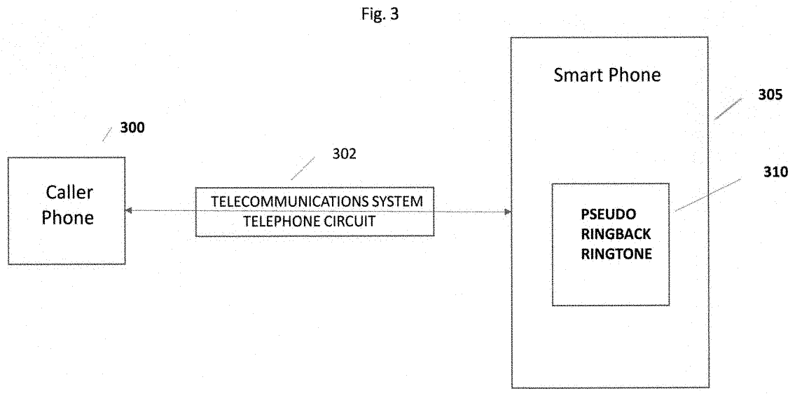

FIG. 3 illustrates a method of creating a ringer delay 330 when receiving an incoming call on a ringer delay ringtone, RDR, smart phone 310 using a ringer delay ringtone, RDR 320.

A telecommunication system telephone circuit routes and connects an incoming call from a caller phone 300 to RDR smart phone 310, completing a telephone circuit. Simultaneously with the completion of the telephone circuit connection, ringback tones are received by the caller phone 300, and the RDR smart phone 310 starts playing an RDR 320 that plays silence for a temporary period of time creating a ringer delay 330.

The first part of the two-part RDR 320 contains an audio file that has an audio volume amplitude of zero, silence. The first part of the audio file plays for the duration of the ringer delay 330 and the RDR smart phone 310 cannot audibly ring.

Ringback tones are heard by the caller phone 300 when the caller phone 300 is connected to the RDR smart phone 310. The caller hears ringback tones and mistakenly associates the ringback tones with the ringing of the RDR smart phone 310 when the ringback tones only signify that the two phones are connected.

During the ringer delay 330, the deceptive ringback tones sent to caller phone 300 are deemed to be pseudo ringback tones 340 because they deceive the caller to think the RDR smart phone 310 is ringing; it is audibly silent.

The ringer delay 330 created when the RDR 320 begins to play silence continues for the length of the temporary ringer delay 330. The RDR 320 length, a fixed or variable number of seconds, can be preset by the manufacturer or it can be a user input to the RDR smart phone 310.

Before the called RDR smart phone 310 ringer delay 330 expires and while an annoying caller is still hearing pseudo ringback tones 340; the annoying, impatient caller is persuaded to hang up and call another more promptly answered phone.

The silent part of the RDR 320 audio file, ringer delay 330, is typically equal to about, but not limited to, four pseudo ringback tones 340 as heard by the caller. Four deceptive ringback tones are equal to, but not limited to, fifteen seconds of a nominal thirty-second-long RDR 320 audio file.

The fifteen second ringer delay 330 of silence is a sufficient amount of time to deter most annoying callers and it prevents annoying one, two, or three-ring hang-ups from ringing an RDR smart phone 310.

After the RDR smart phone 310 fifteen seconds ringer delay 330 expires, the RDR 320 begins to play the second half of the RD ringtone 320 audible file that contains ringtone sounds; the telephone circuit remains connected; ringback tones 350 replace pseudo ringback tones 340 heard on the caller phone 300.

If the caller is patient and stays on the line until the ringer delay 330 expires; the RDR smart phone 310 user can answer the call or hang-up 360; converse with the patient caller 370; or let the call go to voice mail 380, if available.

1-9: (canceled)

10. A method of defeating or deterring an annoying call, comprising:
A telecommunications system telephone circuit means for receiving- and modifying said call carrier components,
without identifying or interrogating said call, said circuit means inserts a randomly varied pseudo ringback pause into said call carrier components, immediately after said call carrier connect signal and preceding a ring through signal,
routing said modified call to a called phone,
resulting in keeping said called phone silent during said pause while allowing a telephone circuit generated group of deceptive pseudo ringback sounds to play to said caller,
ringback sounds continue to said caller following said pause expiration,
concurrent with said pause expiration said ring though audibly announces said call on said called phone.

11. A method of defeating or deterring an annoying call, comprising:
A smart phone operating system or app means for receiving and modifying a call coming from a telecommunications system telephone circuit,
without identifying or interrogating said call, said smart phone operating system or app means inserts a variable pseudo ringback pause into said call carrier components, immediately after said call carrier connect signal and preceding a ring through signal,
resulting in keeping said smart phone silent during said pause while allowing a telephone circuit generated group of pseudo ringback sounds to play to a caller,
said ringback sounds continue to said caller following said pause expiration,
during said pseudo ringback pause said smart phone displays caller ID information, concurrent with said pause expiration said ring though audibly announces said call on said smart phone.

12. A method of defeating or deterring an annoying call, comprising:
A smart phone for receiving said call coming from a telecommunications system telephone circuit, without identifying or interrogating said call,
said smart phone connects said call allowing a telephone circuit generated group of pseudo ringback sounds to play to a caller,
concurrent with said call connection said smart phone begins playing a two-part contiguous pseudo ringback ringtone,
part-one of said ringtone begins non-audibly announcing said call by playing silence, preventing said smart phone from ringing, creating a deceptive pseudo ringback pause,
non-audibly announcing, silence, is accomplished by part-one of the ringtone having a sound amplitudes of zero,
following said part-one, said part-two of said ringtone begins playing sounds audibly announcing said call while ringback sounds continue playing to said caller.
